(19) United States
(12) Patent Application Publication
(10) Pub. No.: US 2022/0172310 A1
(43) Pub. Date: Jun. 2, 2022

(54) HOUSE-RENTING RECOMMENDATION METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: An ZHUO, Beijing (CN); Yu CHEN, Beijing (CN); Huan LIU, Beijing (CN); Shuai LI, Beijing (CN); Jia WANG, Beijing (CN); Chunfeng LI, Beijing (CN); Wei YANG, Beijing (CN); Hao CHEN, Beijing (CN); Shu ZHANG, Beijing (CN)

(73) Assignee: BEIJING BAIDU NETCOM SCIENCE TECHNOLOGY CO., LTD., Beijing (CN)

(21) Appl. No.: 17/651,788

(22) Filed: Feb. 18, 2022

(30) Foreign Application Priority Data
Apr. 6, 2021 (CN) 202110369158.6

(51) Int. Cl. G06Q 50/16; G06Q 30/06; G06N 5/02

(52) U.S. Cl. CPC G06Q 50/16; G06N 5/02; G06Q 30/0631

(57) ABSTRACT

Provided is a house-renting recommendation method. The method includes: receiving a destination and a house-renting requirement input by a current user; where the house-renting requirement includes at least a commuting time and a house-renting expense; inputting, into a pre-trained recommendation model, the destination and the house-renting requirement input by the current user; outputting, through the recommendation model, a search result for the current user based on a pre-constructed house-renting knowledge graph; and recommending, in response to the search result for the current user comprising information about at least one candidate housing resource, the information about the at least one candidate housing resource to the current user.

### CROSS-REFERENCE TO RELATED APPLICATION

This application claims priority to Chinese Patent Application No. 202110369158.6 filed on Apr. 6, 2021, the disclosure of which is incorporated herein by reference in its entirety.

### TECHNICAL FIELD

The present disclosure relates to the technical field of artificial intelligence and further to the technical field of deep learning and knowledge graph, in particular, a house-renting recommendation method and apparatus, an electronic device and a storage medium.

### BACKGROUND

Food, clothing, housing and transportation are the most basic demands of people's lives, among which the housing-related house-renting is a unavoidable topic for most young people today. According to statistics, more and more people having house-renting demands use the online house-searching method to find a convenient place to live for work. The online house-searching products on the market are usually difficult to meet those people's demands. Users always need to spend a lot of time and energy in constantly screening houses, asking colleagues and friends and viewing on-site houses before finding the houses that meet the users' demands; and after renting the houses, some users discover that the real commuting conditions of the houses to their companies are inconsistent with the information described in the online house-searching products. As a result, the house-searching results are dissatisfactory.

Users have to take many times of trial and error to find houses that really suit the users. However, for most users having the house-renting demands, especially for newly-graduated young people, they are strangers in strange places and thereby do not know where their colleagues live, what the commuting conditions near the companies are really like or whether the selected houses are inconvenient for going to work. But forced by reality, they have to find a convenient and affordable house for work in a short time. Apparently, the house-searching products on the market cannot meet the users' demands, making the renting journey of the users more difficult.

### SUMMARY

The present disclosure provides a house-renting recommendation method, an electronic device and a storage medium.

In a first aspect, the present disclosure provides a house-renting recommendation method, and the method includes the steps below.

A destination and a house-renting requirement input by a current user are received, where the house-renting requirement includes at least a commuting time and a house-renting expense.

The destination and the house-renting requirement input by the current user are input into a pre-trained recommendation model, and a search result for the current user is output based on a pre-constructed house-renting knowledge graph through the recommendation model.

In response to the search result for the current user including information about at least one candidate housing resource, the information about the at least one candidate housing resource is recommended to the current user.

In a second aspect, an embodiment of the present disclosure provides an electronic device. The electronic device includes at least one processor and a memory communicatively connected to the at least one processor.

The memory is configured to store instructions executable by the at least one processor, and the instructions are configured to, when executed by the at least one processor, cause the at least one processor to perform the the house-renting recommendation method according to any embodiment of the present disclosure.

In a third aspect, an embodiment of the present disclosure provides a non-transitory computer-readable storage medium storing computer instructions, where the computer instructions are configured to cause a computer to perform the house-renting recommendation method according to any embodiment of the present disclosure.

According to technologies of the present disclosure, the technical problem is solved that the house-searching products in the related art cannot meet users' demands and that the users need to spend a lot of time and energy before finding the houses that really suit the users. The technical solutions provided by the present disclosure can meet different users' house-renting demands, achieve personalized, reasonable and intelligent recommendation effects and facilitate the final house-renting decision of a user.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the present solution and not to limit the present disclosure.

FIG. 1 is a first flowchart of a house-renting recommendation method according to an embodiment of the present disclosure.

FIG. 2 is a second flowchart of a house-renting recommendation method according to an embodiment of the present disclosure.

FIG. 3 is a view illustrating the structure of a house-renting knowledge graph according to an embodiment of the present disclosure.

FIG. 4 is a third flowchart of a house-renting recommendation method according to an embodiment of the present disclosure.

FIG. 5 is a view illustrating the structure of a house-renting recommendation apparatus according to an embodiment of the present disclosure.

FIG. 6 is a block diagram of an electronic device for implementing the house-renting recommendation method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it will be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

### Embodiment One

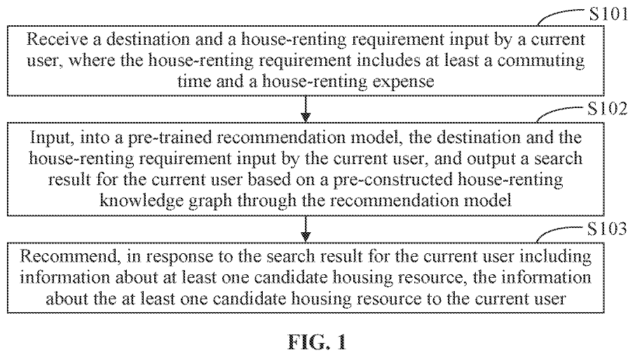

FIG. 1 is a flowchart of a house-renting recommendation method according to an embodiment of the present disclosure. The method may be executed by a house-renting recommendation apparatus or an electronic device. The apparatus or the electronic device may be implemented by software and/or hardware. The apparatus or the electronic device may be integrated in any intelligent device having a network communication function. As shown in FIG. 1, the house-renting recommendation method may include the steps below.

In S101, a destination and a house-renting requirement input by a current user are received, where the house-renting requirement includes at least a commuting time and a house-renting expense.

In this step, an electronic device may be configured to receive the destination and the house-renting requirement input by the current user, where the house-renting requirement includes at least the commuting time and the house-renting expense. For example, the electronic device may be configured to provide at least three input boxes for the current user on a user interface of a house-renting application (APP for short). For example, the user interface may display a first input box, a second input box and a third input box; after the current user opens the user interface, the current user may input the destination in the first input box, the commuting time in the second input box and the house-renting expense in the third input box.

In S102, the destination and the house-renting requirement input by the current user are input into a pre-trained recommendation model, and a search result for the current user is output based on a pre-constructed house-renting knowledge graph through the recommendation model.

In this step, the electronic device may input, into the pre-trained recommendation model, the destination and the house-renting requirement input by the current user and output the search result for the current user based on the pre-constructed house-renting knowledge graph through the recommendation model. The search result may include information that none of candidate housing resources is found and information that at least one candidate housing resource is found. The information that none of candidate housing resources is found indicates that none of housing resources matching the current user's house-renting requirement is found based on the house-renting knowledge graph, and the information that at least one candidate housing resource is found indicates that at least one housing resources matching the current user's house-renting requirement is found based on the house-renting knowledge graph. In the embodiment of the present disclosure, the electronic device may search, in the house-renting knowledge graph, for housing resource information matching the destination and the house-renting requirement; and determine, in response to information about at least one housing resource matching the destination and the house-renting requirement being found in the house-renting knowledge graph, the information about the at least one housing resource matching the destination and the house-renting requirement as information about at least one candidate housing resource.

In S103, in response to the search result for the current user including information about at least one candidate housing resource, the information about the at least one candidate housing resource is recommended to the current user.

In this step, in response to the search result for the current user including the information about the at least one candidate housing resource, the electronic device may recommend the information about the at least one candidate housing resource to the current user. For example, the electronic device may directly recommend the information about the at least one candidate housing resource to the current user, or the electronic device may first sort the information about the at least one candidate housing resource and recommend sorted information about at least one candidate housing resource to the current user; further, the electronic device may also select and recommend, from the sorted information about the at least one candidate housing resource, information about one or more candidate housing resources to the current user.

In the house-renting recommendation method provided by the embodiment of the present disclosure, the destination and the house-renting requirement input by the current user are first received and then input into the pre-trained recommendation model, the search result for the current user are output based on the pre-constructed house-renting knowledge graph through the recommendation model, and in response to the search result for the current user including the information about the at least one candidate housing resource, the information about the at least one candidate housing resource is recommended to the current user. That is, the present disclosure may pre-construct the house-renting knowledge graph, and the current user may input the destination and the house-renting requirement, where the house-renting requirement may include at least the commuting time and the house-renting expense, and the present disclosure outputs the search result for the current user based on the house-renting knowledge graph. The house-searching products in the related art cannot meet users' demands, and the users need to spend a lot of time and energy before finding the houses that really suit the users. The present disclosure uses the technical methods of pre-constructing the house-renting knowledge graph and acquiring the candidate housing resources matching the current user based on the house-renting knowledge graph, so the technical problem can be overcome that the house-searching products in the related art cannot meet users' demands and that the users need to spend a lot of time and energy before finding the houses that really suit the users. The technical solution provided by the present disclosure can meet different users' house-renting demands and achieve personalized, reasonable and intelligent recommendation effects and facilitate the final house-renting decision of a user. Moreover, the technical solution according to the embodiment of the present disclosure is easy and convenient to implement, is convenient to popularize and has a wider scope of application.

### Embodiment Two

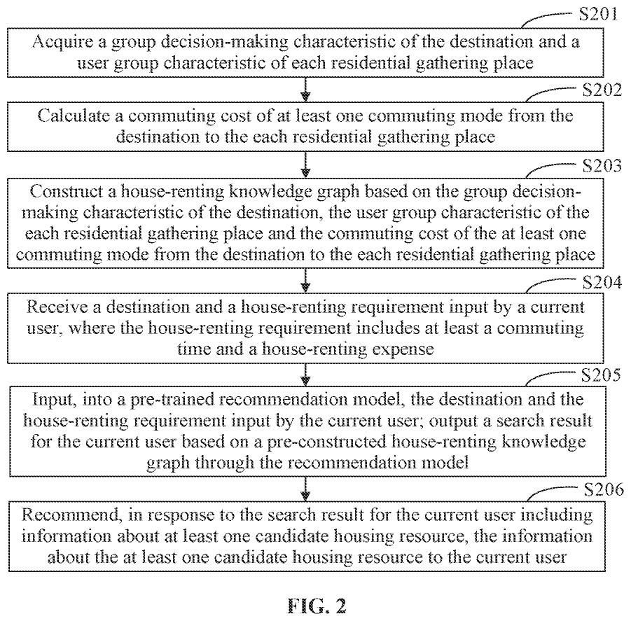

FIG. 2 is a second flowchart of a house-renting recommendation method according to an embodiment of the present disclosure. This embodiment is an optimization and expansion of the preceding technical solution and can be combined with each preceding optional implementation. As shown in FIG. 2, the house-renting recommendation method may include the steps below.

In S201, a group decision-making characteristic of the destination and a user group characteristic of each residential gathering place are acquired.

In this step, the electronic device may acquire the group decision-making characteristic of the destination and the user group characteristic of the each residential gathering place, where the group decision-making characteristic is configured to indicate the distribution characteristic of people arriving at the destination and includes, but is not limited to, regional information of the people arriving at the destination, business-circle information of the people arriving at the destination or residential quarter information of the people arriving at the destination; and the user group characteristic is configured to indicate the group characteristic of users in the each residential gathering place and includes, but is not limited to, an occupation distribution of the users in the each residential gathering place, an age distribution of the users in the each residential gathering place or an income-level distribution of the users in the each residential gathering place. For example, the present disclosure may pre-determine at least one destination and at least one residential gathering place; the at least one destination may be one or more working units; the at least one residential gathering place may be one or more residential quarters; and then the group decision-making characteristic of each working unit and the user group characteristic of each residential quarter are acquired.

In S202, a commuting cost of at least one commuting mode from the destination to the each residential gathering place is calculated.

In this step, the electronic device may calculate the commuting cost of the at least one commuting mode from the destination to the each residential gathering place, where the at least one commuting mode includes, but is not limited to, at least one of driving, taking a bus, taking the subway, taking a taxi or walking; and the commuting cost includes a time cost and an expense cost.

In S203, a house-renting knowledge graph is constructed based on the group decision-making characteristic of the destination, the user group characteristic of the each residential gathering place and the commuting cost of the at least one commuting mode from the destination to the each residential gathering place.

In this step, the electronic device may construct the house-renting knowledge graph based on the group decision-making characteristic of the destination, the user group characteristic of the each residential gathering place and the commuting cost of the at least one commuting mode from the destination to the each residential gathering place. Knowledge graph, known as the knowledge domain visualization or knowledge domain mapping map in the library and information science, is a series of various graphs showing the relationship between the knowledge development progress and the structure, uses visualization technologies to describe knowledge resources and the carriers thereof, mines, analyzes, constructs, draws and displays the interrelationships between knowledge, the knowledge sources and the carriers thereof

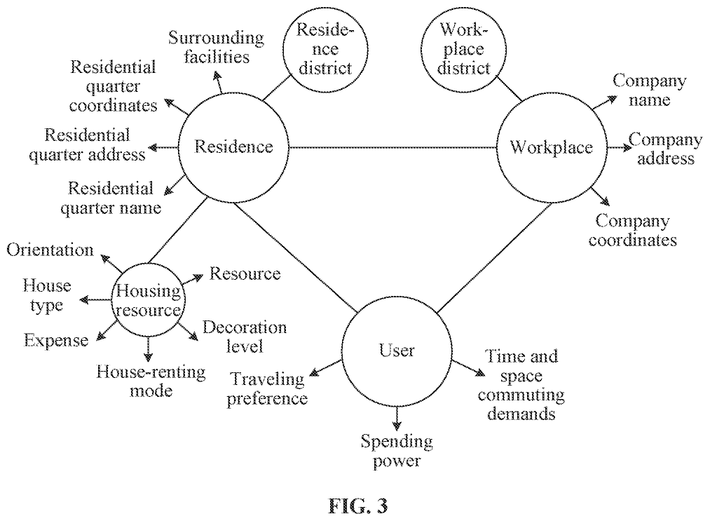

FIG. 3 is a view illustrating the structure of a house-renting knowledge graph according to an embodiment of the present disclosure. As shown in FIG. 3, the present disclosure may construct the house-renting knowledge graph in multiple dimensions and includes, but is not limited to, workplace, residence, housing resource and user. The residence and the workplace may be related in such methods as the statistics on the proportion of round-trips in the district, the statistics on time and space of commuting routes and the commuting modes (driving, taking a bus, biking, walking or taking a taxi); the residence and the housing resource may be related in such modes as the house-renting expense, the number of housing resources and the newly-increased housing resources; the residence and the user may be related by whether the user lives in the residence; and the workplace and the user may be related by whether the user works in the workplace. For example, the workplace-related information includes, but is not limited to, company name, company address, company coordinates and the like; the residence-related information includes, but is not limited to, residential quarter name, residential quarter address, residential quarter coordinates, surrounding facilities (interest points such as transportation, food and subway) the like; further, the house-renting knowledge graph also includes a residence district related to each residence and a workplace district related to each workplace; additionally, the housing resource-related information includes, but is not limited to, orientation, house type, house-renting expense, house-renting mode (non-shared renting or shared renting), decoration level, source and the like; and the user-related information includes, but is not limited to, traveling preference, spending power, time and space commuting demands and the like.

In S204, a destination and a house-renting requirement input by a current user are received, where the house-renting requirement includes at least a commuting time and a house-renting expense.

In S205, the destination and the house-renting requirement input by the current user are input into a pre-trained recommendation model, and a search result for the current user is output based on a pre-constructed house-renting knowledge graph through the recommendation model.

In S206, in response to the search result for the current user including information about at least one candidate housing resource, the information about the at least one candidate housing resource is recommended to the current user.

In the house-renting recommendation method provided by the embodiment of the present disclosure, the destination and the house-renting requirement input by the current user are first received and then input into the pre-trained recommendation model, the search result for the current user is output based on the pre-constructed house-renting knowledge graph through the recommendation model, and in response to the search result for the current user including the information about the at least one candidate housing resource, the information about the at least one candidate housing resource is recommended to the current user. That is, the present disclosure may pre-construct the house-renting knowledge graph, and the current user may input the destination and the house-renting requirement, where the house-renting requirement includes at least the commuting time and the house-renting expense, and the present disclosure outputs the search result for the current user based on the house-renting knowledge graph. The house-searching products in the related art cannot meet users' demands, and the users need to spend a lot of time and energy before finding the houses that really suit the users. The present disclosure uses the technical method of pre-constructing the house-renting knowledge graph and acquiring the candidate housing resources matching the current user based on the house-renting knowledge graph, so the technical problem can be overcome that the house-searching products in the related art cannot meet users' demands and that the users need to spend a lot of time and energy before finding the houses that really suit the users. The technical solution provided by the present disclosure can meet different users' house-renting demands and achieve personalized, reasonable and intelligent recommendation effects and facilitate the final house-renting decision of a user. Moreover, the technical solution according to the embodiment of the present disclosure is easy and convenient to implement, is convenient to popularize and has a wider scope of application.

### Embodiment Three

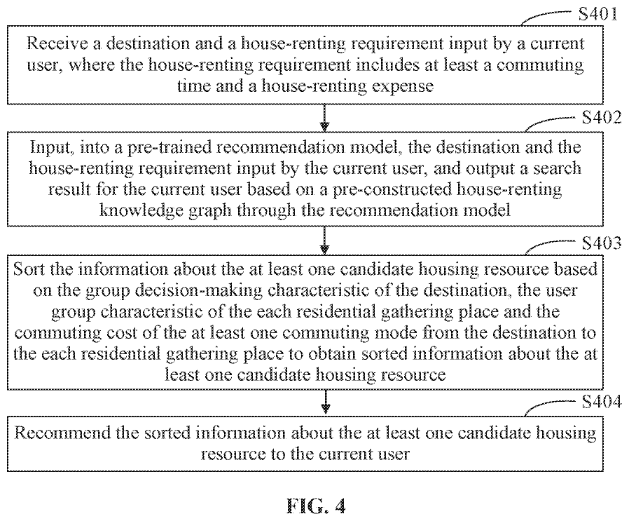

FIG. 4 is a third flowchart of a house-renting recommendation method according to an embodiment of the present disclosure. This embodiment is an optimization and expansion of the preceding technical solution and can be combined with each preceding optional implementation. As shown in FIG. 4, the house-renting recommendation method includes the steps below.

In S401, a destination and a house-renting requirement input by a current user are received, where the house-renting requirement includes at least a commuting time and a house-renting expense.

In S402, the destination and the house-renting requirement input by the current user are input into a pre-trained recommendation model, and a search result for the current user is output based on a pre-constructed house-renting knowledge graph through the recommendation model.

In S403, information about at least one candidate housing resource is sorted based on a group decision-making characteristic of the destination, a user group characteristic of each residential gathering place and a commuting cost of at least one commuting mode from the destination to the each residential gathering place to obtain sorted information about the at least one candidate housing resource.

In this step, the electronic device may sort the information about the at least one candidate housing resource based on the group decision-making characteristic of the destination, the user group characteristic of the each residential gathering place and the commuting cost of the at least one commuting mode from the destination to the each residential gathering place to obtain the sorted information about the at least one candidate housing resource. For example, the electronic device may input the information about the at least one candidate housing resource included in the search result into a pre-trained sorting model, and the sorted information about the at least one candidate housing resource is output based on the group decision-making characteristic of the destination, the user group characteristic of the each residential gathering place and the commuting cost of the at least one commuting mode from the destination to the each residential gathering place through the sorting model. For example, the sorting model may be a DeepFM model; the DeepFM model may include two parts: a neural network responsible for extracting low-order characteristics and a factorization machine responsible for extracting high-order characteristics; the two parts share the same input.

In S404, the sorted information about the at least one candidate housing resource is recommended to the current user.

In this step, the electronic device may recommend the sorted information about the at least one candidate housing resource to the current user. For example, the electronic device may recommend all the sorted information about the at least one candidate housing resource to the current user, or the electronic device may also select and recommend, from the sorted information about the at least one candidate housing resource, information about one or more candidate housing resources to the current user. For example, the electronic device may recommend all the sorted information about the at least one candidate housing resource to the current user based on the click-through-rate (CTR for short).

In the specific embodiment of the present disclosure, the electronic device may also acquire a recommendation reason for one or more of at least one candidate housing resource based on the group decision-making characteristic of the destination, the user group characteristic of the each residential gathering place and the commuting cost of the at least one commuting mode from the destination to the each residential gathering place; and present the recommendation reason for the one or more candidate housing resources of the at least one candidate housing resource to the current user. For example, many colleagues live here, there is a vegetable market near the residential quarter, walking to parks takes short time, the distance to important intersections, subways or schools is short, the traveling is convenient and the like.

In the house-renting recommendation method provided by the embodiment of the present disclosure, the destination and the house-renting requirement input by the current user are first received and then input into the pre-trained recommendation model, the search result for the current user is output based on the pre-constructed house-renting knowledge graph through the recommendation model, and in response to the search result for the current user including the information about the at least one candidate housing resource, the information about the at least one candidate housing resource is recommended to the current user. That is, the present disclosure may pre-construct the house-renting knowledge graph, and the current user may input the destination and the house-renting requirement, where the house-renting requirement includes at least the commuting time and the house-renting expense, and the present disclosure outputs the search result for the current user based on the house-renting knowledge graph. The house-searching products in the related art cannot meet users' demands, and the users need to spend a lot of time and energy before finding the houses that really suit the users. The present disclosure uses the technical methods of pre-constructing the house-renting knowledge graph and acquiring the candidate housing resources matching the current user based on the house-renting knowledge graph, so the technical problem is overcome that the house-searching products in the related art cannot meet users' demands and that the users need to spend a lot of time and energy before finding the houses that really suit the users. The technical solution provided by the present disclosure can meet different users' house-renting demands, achieve the personalized, reasonable and intelligent recommendation effects and facilitate the final house-renting decision of a user. Moreover, the technical solution according to the embodiment of the present disclosure is easy and convenient to implement, is convenient to popularize and has a wider scope of application.

### Embodiment Four

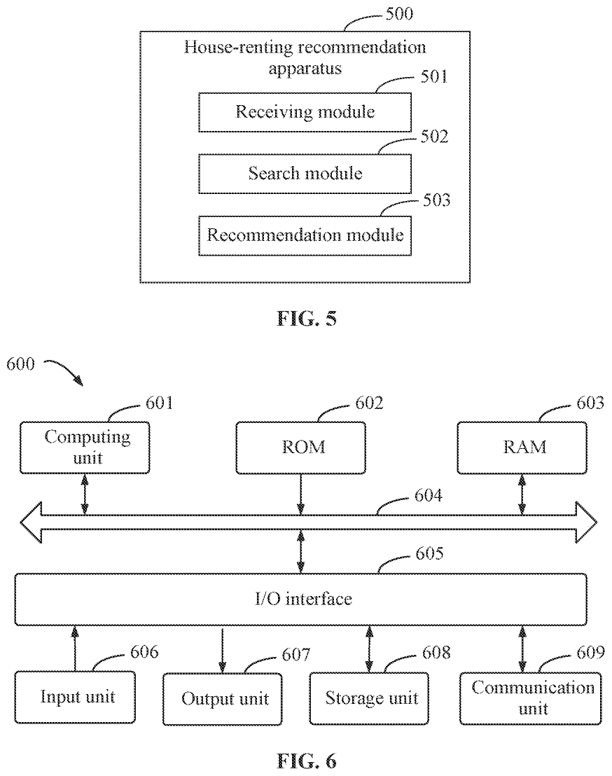

FIG. 5 is a view illustrating the structure of a house-renting recommendation apparatus according to an embodiment of the present disclosure. As shown in FIG. 5, the apparatus 500 includes a receiving module 501, a search module 502 and a recommendation module 503.

The receiving module 501 is configured to receive a destination and a house-renting requirement input by a current user, where the house-renting requirement includes at least a commuting time and a house-renting expense.

The search module 502 is configured to input, into a pre-trained recommendation model, the destination and the house-renting requirement input by the current user, and output a search result for the current user based on a pre-constructed house-renting knowledge graph through the recommendation model.

The recommendation module 503 is configured to recommend, in response to the search result for the current user including information about at least one candidate housing resource, the information about the at least one candidate housing resource to the current user.

Further, the apparatus also includes a construction module 504 (not shown), and the construction module 504 is configured to acquire a group decision-making characteristic of the destination and a user group characteristic of each residential gathering place; calculate a commuting cost of at least one commuting mode from the destination to the each residential gathering place; and construct a house-renting knowledge graph based on the group decision-making characteristic of the destination, the user group characteristic of the each residential gathering place and the commuting cost of the at least one commuting mode from the destination to the each residential gathering place.

Further, the group decision-making characteristic includes, but is not limited to, regional information of people arriving at the destination, business-circle information of the people arriving at the destination or residential quarter information of the people arriving at the destination; the user group characteristic includes, but is not limited to, an occupation distribution of users in the each residential gathering place, an age distribution of the users in the residential gathering place or an income-level distribution of the users in the each residential gathering place; the at least one commuting mode includes, but is not limited to, at least one of driving, taking a bus, taking the subway, taking a taxi or walking; and the commuting cost includes a time cost and an expense cost.

Further, the search module 502 is configured to search, in the house-renting knowledge graph, for housing resource information matching the destination and the house-renting requirement; and determine, in response to information about at least one housing resource matching the destination and the house-renting requirement being found in the house-renting knowledge graph, the information about the at least one housing resource matching the destination and the house-renting requirement as the information about the at least one candidate housing resource.

Further, the recommendation module 503 is configured to sort the information about the at least one candidate housing resource based on the group decision-making characteristic of the destination, the user group characteristic of the each residential gathering place and the commuting cost of the at least one commuting mode from the destination to the each residential gathering place to obtain sorted information about the at least one candidate housing resource; and recommend the sorted information about the at least one candidate housing resource to the current user.

Further, the recommendation module 503 is also configured to acquire a recommendation reason for one or more of at least one candidate housing resource based on the group decision-making characteristic of the destination, the user group characteristic of the each residential gathering place and the commuting cost of the at least one commuting mode from the destination to the each residential gathering place; and present the recommendation reason for the one or more candidate housing resources of the at least one candidate housing resource to the current user.

The preceding house-renting recommendation apparatus can execute the method provided by any embodiment of the present disclosure and has functional modules and beneficial effects corresponding to the executed method. For technical details not described in detail in the embodiment, reference may be made to the house-renting recommendation method provided by any embodiment of the present disclosure.

Embodiment five

According to an embodiment of the present disclosure, the present disclosure also provides an electronic device, a readable storage medium and a computer program product.

FIG. 6 is a block diagram of an exemplary electronic device 600 that may be configured to implement the embodiments of the present disclosure. Electronic devices are intended to represent various forms of digital computers, for example, laptop computers, desktop computers, worktables, personal digital assistants, servers, blade servers, mainframe computers and other applicable computers. Electronic devices may further represent various forms of mobile apparatuses, for example, personal digital assistants, cellphones, smartphones, wearable devices and other similar computing apparatuses. Herein the shown components, the connections and relationships between these components, and the functions of these components are illustrative only and are not intended to limit the implementation of the present disclosure as described and/or claimed herein.

As shown in FIG. 6, the device 600 includes a computing unit 601. The computing unit 601 may be configured to perform various types of appropriate operations and processing based on a computer program stored in a read-only memory (ROM) 602 or a computer program loaded from a storage unit 608 to a random-access memory (RAM) 603. Various programs and data required for operations of the device 600 may also be stored in the RAM 603. The computing unit 601, the ROM 602 and the RAM 603 are connected to each other through a bus 604. An input/output (I/O) interface 605 is also connected to the bus 604.

Multiple components in the device 600 are connected to the I/O interface 605. The multiple components include an input unit 606 such as a keyboard and a mouse, an output unit 607 such as various types of displays and speakers, the storage unit 608 such as a magnetic disk and an optical disk, and a communication unit 609 such as a network card, a modem or a wireless communication transceiver. The communication unit 609 allows the device 600 to exchange information/data with other devices over a computer network such as the Internet and/or various telecommunications networks.

The computing unit 601 may be various general-purpose and/or dedicated processing components having processing and computing capabilities. Some examples of the computing unit 601 include, but are not limited to, central processing units (CPUs), graphics processing units (GPUs), various dedicated artificial intelligence (AI) computing chips, various computing units running machine learning models and algorithms, digital signal processors (DSPs) and any suitable processors, controllers and microcontrollers. The computing unit 601 performs various methods and processing described in the preceding, such as the house-renting recommendation method. For example, in some embodiments, the house-renting recommendation method may be implemented as a computer software program tangibly contained in a machine-readable medium such as the storage unit 608. In some embodiments, part or all of computer programs may be loaded and/or installed on the device 600 via the ROM 602 and/or the communication unit 609. When the computer program is loaded to the RAM 603 and executed by the computing unit 601, one or more steps of the preceding house-renting recommendation method may be performed. Alternatively, in other embodiments, the computing unit 601 may be configured, in any other suitable manner (for example, by means of firmware), to perform the house-renting recommendation method.

Herein various embodiments of the systems and technologies described in the preceding may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof The various embodiments may include implementations in one or more computer programs. The one or more computer programs are executable and/or interpretable on a programmable system including at least one programmable processor. The at least programmable processor may be a dedicated or general-purpose programmable processor for receiving data and instructions from a memory system, at least one input apparatus and at least one output apparatus and transmitting the data and instructions to the memory system, the at least one input apparatus and the at least one output apparatus.

Program codes for implementing the methods of the present disclosure may be compiled in any combination of one or more programming languages. The program codes may be provided for the processor or controller of a general-purpose computer, a special-purpose computer or another programmable data processing apparatus to enable functions/operations specified in a flowchart and/or a block diagram to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with a system, apparatus or device that executes instructions. The machine-readable medium may be a machine-readable signal medium or a machine-readable storage medium. Machine-readable media may include, but are not limited to, electronic, magnetic, optical, electromagnetic, infrared or semiconductor systems, apparatuses or devices or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device or any suitable combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of apparatuses may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. The clients and servers are usually far away from each other and generally interact through the communication network. The relationship between the client and the server arises by virtue of computer programs running on respective computers and having a client-server relationship to each other. The server may be a cloud server, also referred to as a cloud computing server or a cloud host, which is a host product in a cloud computing service system, so as to solve the defects of difficult management and weak traffic scalability in traditional physical hosts and VPS services.

It is to be understood that various forms of the preceding flows may be used, with steps reordered, added or removed. For example, the steps described in the present disclosure may be executed in parallel, in sequence or in a different order as long as the desired result of the technical solution disclosed in the present disclosure is achieved. The execution sequence of these steps is not limited herein. In the technical solutions in the present disclosure, acquisition, storage and application of user personal information involved are in compliance with relevant laws and regulations and do not violate the public order and good customs.

The scope of the present disclosure is not limited to the preceding embodiments. It is to be understood by those skilled in the art that various modifications, combinations, sub-combinations, and substitutions may be made depending on design requirements and other factors. Any modifications, equivalent substitutions, improvements and the like made within the spirit and principle of the present disclosure are within the scope of the present disclosure.

What is claimed is:

1. A house-renting recommendation method, comprising:
receiving a destination and a house-renting requirement input by a current user, wherein the house-renting requirement comprises at least a commuting time and a house-renting expense;
inputting, into a pre-trained recommendation model, the destination and the house-renting requirement input by the current user, and outputting, through the recommendation model, a search result for the current user based on a pre-constructed house-renting knowledge graph; and recommending, in response to the search result for the current user comprising information about at least one candidate housing resource, the information about the at least one candidate housing resource to the current user.

2. The method according to claim 1, before receiving the destination and the house-renting requirement input by the current user, the method further comprising:
acquiring a group decision-making characteristic of the destination and a user group characteristic of each residential gathering place;
calculating a commuting cost of at least one commuting mode from the destination to the each residential gathering place; and
constructing the house-renting knowledge graph based on the group decision-making characteristic of the destination, the user group characteristic of the each residential gathering place and the commuting cost of the at least one commuting mode from the destination to the each residential gathering place.

3. The method according to claim 2, wherein the group decision-making characteristic comprises regional information of people arriving at the destination, business-circle information of the people arriving at the destination or residential quarter information of the people arriving at the destination; the user group characteristic comprises an occupation distribution of users in the each residential gathering place, an age distribution of the users in the each residential gathering place or an income-level distribution of the users in the each residential gathering place; the at least one commuting mode comprises at least one of driving, taking a bus, taking a subway, taking a taxi or walking; and the commuting cost comprises a time cost and an expense cost.

4. The method according to claim 1, wherein outputting, through the recommendation model, the search result for the current user based on the pre-constructed house-renting knowledge graph comprises:
searching, in the house-renting knowledge graph, for housing resource information matching the destination and the house-renting requirement; and
determining, in response to information about at least one housing resource matching the destination and the house-renting requirement being found in the house-renting knowledge graph, the information about the at least one housing resource matching the destination and the house-renting requirement as the information about the at least one candidate housing resource.

5. The method according to claim 2, wherein recommending the information about the at least one candidate housing resource to the current user comprises:
sorting the information about the at least one candidate housing resource based on the group decision-making characteristic of the destination, the user group characteristic of the each residential gathering place and the commuting cost of the at least one commuting mode from the destination to the each residential gathering place to obtain sorted information about the at least one candidate housing resource; and
recommending the sorted information about the at least one candidate housing resource to the current user.

6. The method according to claim 5, further comprising:
acquiring a reason for recommending one or more of at least one candidate housing resource based on the group decision-making characteristic of the destination, the user group characteristic of the each residential gathering place and the commuting cost of the at least one commuting mode from the destination to the each residential gathering place; and
presenting, to the current user, the reason for recommending the one or more candidate housing resources of the at least one candidate housing resource.

7. An electronic device, comprising:
at least one processor; and
a memory communicatively connected to the at least one processor;
wherein the memory is configured to store instructions executable by the at least one processor, and the instructions are configured to, when executed by the at least one processor, cause the at least one processor to perform the following:
receiving a destination and a house-renting requirement input by a current user, wherein the house-renting requirement comprises at least a commuting time and a house-renting expense;
inputting, into a pre-trained recommendation model, the destination and the house-renting requirement input by the current user, and outputting, through the recommendation model, a search result for the current user based on a pre-constructed house-renting knowledge graph; and recommending, in response to the search result for the current user comprising information about at least one candidate housing resource, the information about the at least one candidate housing resource to the current user.

8. The device according to claim 7, wherein the instructions are configured to, when executed by the at least one processor, further cause the at least one processor to perform, before receiving the destination and the house-renting requirement input by the current user, the following:
acquiring a group decision-making characteristic of the destination and a user group characteristic of each residential gathering place;
calculating a commuting cost of at least one commuting mode from the destination to the each residential gathering place; and
constructing the house-renting knowledge graph based on the group decision-making characteristic of the destination, the user group characteristic of the each residential gathering place and the commuting cost of the at least one commuting mode from the destination to the each residential gathering place.

9. The device according to claim 8, wherein the group decision-making characteristic comprises regional information of people arriving at the destination, business-circle information of the people arriving at the destination or residential quarter information of the people arriving at the destination; the user group characteristic comprises an occupation distribution of users in the each residential gathering place, an age distribution of the users in the each residential gathering place or an income-level distribution of the users in the each residential gathering place; the at least one commuting mode comprises at least one of driving, taking a bus, taking a subway, taking a taxi or walking; and the commuting cost comprises a time cost and an expense cost.

10. The device according to claim 7, wherein outputting, through the recommendation model, the search result for the current user based on the pre-constructed house-renting knowledge graph comprises:
searching, in the house-renting knowledge graph, for housing resource information matching the destination and the house-renting requirement; and
determining, in response to information about at least one housing resource matching the destination and the house-renting requirement being found in the house-renting knowledge graph, the information about the at least one housing resource matching the destination and the house-renting requirement as the information about the at least one candidate housing resource.

11. The device according to claim 8, wherein recommending the information about the at least one candidate housing resource to the current user comprises:
sorting the information about the at least one candidate housing resource based on the group decision-making characteristic of the destination, the user group characteristic of the each residential gathering place and the commuting cost of the at least one commuting mode from the destination to the each residential gathering place to obtain sorted information about the at least one candidate housing resource; and
recommending the sorted information about the at least one candidate housing resource to the current user.

12. The device according to claim 11, wherein the instructions are configured to, when executed by the at least one processor, further cause the at least one processor to perform the following:
acquiring a reason for recommending one or more of at least one candidate housing resource based on the group decision-making characteristic of the destination, the user group characteristic of the each residential gathering place and the commuting cost of the at least one commuting mode from the destination to the each residential gathering place; and
presenting, to the current user, the reason for recommending the one or more candidate housing resources of the at least one candidate housing resource.

13. A non-transitory computer-readable storage medium storing computer instructions, wherein the computer instructions are configured to cause a computer to perform the following:
receiving a destination and a house-renting requirement input by a current user, wherein the house-renting requirement comprises at least a commuting time and a house-renting expense;
inputting, into a pre-trained recommendation model, the destination and the house-renting requirement input by the current user, and outputting, through the recommendation model, a search result for the current user based on a pre-constructed house-renting knowledge graph; and recommending, in response to the search result for the current user comprising information about at least one candidate housing resource, the information about the at least one candidate housing resource to the current user.

14. The storage medium according to claim 13, wherein the computer instructions are further configured to cause the computer to perform, before receiving the destination and the house-renting requirement input by the current user, the following:
acquiring a group decision-making characteristic of the destination and a user group characteristic of each residential gathering place;
calculating a commuting cost of at least one commuting mode from the destination to the each residential gathering place; and
constructing the house-renting knowledge graph based on the group decision-making characteristic of the destination, the user group characteristic of the each residential gathering place and the commuting cost of the at least one commuting mode from the destination to the each residential gathering place.

15. The storage medium according to claim 14, wherein the group decision-making characteristic comprises regional information of people arriving at the destination, business-circle information of the people arriving at the destination or residential quarter information of the people arriving at the destination; the user group characteristic comprises an occupation distribution of users in the each residential gathering place, an age distribution of the users in the each residential gathering place or an income-level distribution of the users in the each residential gathering place; the at least one commuting mode comprises at least one of driving, taking a bus, taking a subway, taking a taxi or walking; and the commuting cost comprises a time cost and an expense cost.

16. The storage medium according to claim 13, wherein outputting, through the recommendation model, the search result for the current user based on the pre-constructed house-renting knowledge graph comprises:
searching, in the house-renting knowledge graph, for housing resource information matching the destination and the house-renting requirement; and
determining, in response to information about at least one housing resource matching the destination and the house-renting requirement being found in the house-renting knowledge graph, the information about the at least one housing resource matching the destination and the house-renting requirement as the information about the at least one candidate housing resource.

17. The storage medium according to claim 14, wherein recommending the information about the at least one candidate housing resource to the current user comprises:
sorting the information about the at least one candidate housing resource based on the group decision-making characteristic of the destination, the user group characteristic of the each residential gathering place and the commuting cost of the at least one commuting mode from the destination to the each residential gathering place to obtain sorted information about the at least one candidate housing resource; and
recommending the sorted information about the at least one candidate housing resource to the current user.

18. The storage medium according to claim 17, wherein the computer instructions are further configured to cause the computer to perform the following:
acquiring a reason for recommending one or more of at least one candidate housing resource based on the group decision-making characteristic of the destination, the user group characteristic of the each residential gathering place and the commuting cost of the at least one commuting mode from the destination to the each residential gathering place; and
presenting, to the current user, the reason for recommending the one or more candidate housing resources of the at least one candidate housing resource.
